(19) United States
(12) Patent Application Publication
(10) Pub. No.: US 2020/0300100 A1
(43) Pub. Date: Sep. 24, 2020

(54) ALLOY TURBINE COMPONENT COMPRISING A MAX PHASE

(71) Applicants: CENTRE NATIONAL DE LA RECHERCHE SCIENTIFIQUE (CNRS), Paris (FR); SAFRAN, Paris (FR)

(72) Inventors: Pierre SALLOT, Moissy-Cramayel Cedex (FR); Veronique BRUNET, Buxerolles (FR); Jonathan CORMIER, Chasseneuil du poitou (FR); Elodie Marthe Bernadette DROUELLE, Poitiers (FR); Sylvain Pierre DUBOIS, Dissay (FR); Patrick VILLECHAIS, Vouneuil sous Biard (FR)

(73) Assignees: CENTRE NATIONAL DE LA RECHERCHE SCIENTIFIQUE (CNRS), Paris (FR); SAFRAN, Paris (FR)

(21) Appl. No.: 16/649,449

(22) PCT Filed: Sep. 21, 2018
(86) PCT No.: PCT/FR2018/052305

§ 371 Date: Mar. 20, 2020

(30) Foreign Application Priority Data
Sep. 21, 2017 (FR) 1758760

(51) Int. Cl. F01D 5/28; B22F 5/04; B22F 3/105; B22F 5/00; C22C 29/10; C04B 35/56; C04B 35/626; C04B 35/645

(52) U.S. Cl. CPC F01D 5/284; B22F 2999/00; B22F 3/105; B22F 5/009; C22C 29/10; C04B 35/5618; C04B 35/6262; C04B 35/645; C04B 2235/3843; C04B 2235/402; C04B 2235/404; C04B 2235/405; C04B 2235/5296; C04B 2235/5436; C04B 2235/761; C04B 2235/77; C01P 2004/03; B22F 2998/10; B22F 5/04

(57) ABSTRACT

A turbine component such as a turbine blade or a vane of a distributor, which includes a polycrystalline substrate containing grains, the substrate having at least one Ti₃AlC₂ phase and the mass fraction of the phase of the alloy is greater than 97%, with the average length of the grains is less than 50 μm, the average width-to-length ratio is between 0.4 and 0.6, and the average mesh volume of the Ti₃AlC₂ phase is less than 152.4 Å³.

### FIELD OF THE INVENTION

The invention relates to a turbine component, such as a turbine blade or an airfoil of a nozzle guide vane, used in aeronautics, and more particularly a turbine component comprising a substrate, the material of which has a MAX phase. The invention also relates to a method for manufacturing such a turbine component.

### STATE OF THE ART

In a jet engine, the exhaust gases released by the combustion chamber can reach high temperatures, greater than 1200° C., or even 1600° C. The components of the jet engine in contact with these exhaust gases, such as turbine blades for example, must thus be capable of keeping their mechanical properties at these high temperatures.

For this purpose, it is known to manufacture certain components of the jet engine from “superalloy”. Superalloys, typically nickel-based, are a family of metallic alloys with high resistance which are able to work at temperatures relatively near to their melting points (typically 0.7 to 0.9 times their melting temperatures).

However, these alloys are very dense, and their mass limits the efficiency of turbines.

For this purpose, the intermetallic alloy TiAL has been used for the manufacturing of turbine components. This material is less dense than a nickel-based superalloy, and its mechanical characteristics make it possible to incorporate components made of TiAL into certain components of a turbine. Specifically, TiAL components can for example have resistance to oxidization up to a temperature of approximately 750° C.

However, TiAl does not currently make it possible to manufacture turbine components having oxidization resistance and sufficient lifetimes at temperatures greater than 800° C., unlike certain nickel-based superalloys.

For this purpose, materials having so-called MAX phases have been used for the manufacturing of turbine components. Materials having a MAX phase are materials of general formula Mₙ₊₁AXₙ where n is an integer between 1 and 3, M is a transition metal (chosen from among Se, Ti, V, Cr, Zr, Nb, Mo, Hf and Ta), A is an element of group A, i.e. chosen from among Al, Si, P, Ga, Ge, As, Cd, In, Sn, Ti and Pb, and X is an element chosen from among carbon and nitrogen. The composition of the MAX phase of a material incurs specific properties of the material relating to oxidization, its density and its withstand to creep, in particular in the range of temperatures corresponding to the operation of the turbine, for example between 800° C. and 1200° C. In particular, it is known to use a material having a Ti₃AlC₂ phase for the manufacturing of a turbine component. This is because the aluminum of a Ti₃AlC₂ phase makes it possible to form a protective layer of alumina, protecting the component from oxidization during the operation of the turbine. The carbon of a Ti₃AlC₂ phase allows the material to have optimal withstand to creep in the temperature range of operation of the turbine. Finally, the titanium of a Ti₃AlC₂ phase allows the material to have a low density in relation to other materials comprising a MAX phase.

The document FR3032449 describes, for example, a material intended to be used in the aeronautical field, having a high mechanical resistance. The material described comprises a first MAX phase of Ti₃AlC₂ type and a second intermetallic phase of TiAl₃ type, the volume fraction of the MAX phase being between 70% and 95% and the volume fraction of the intermetallic phase being between 5% and 30%.

However, the materials described in this document are subject to an oxidization, at 1100° C., that is too high for them to be used for the manufacturing of turbine components in aeronautics.

### SUMMARY OF THE INVENTION

One of the aims of the invention is to propose a solution for manufacturing a turbine component made of material comprising a MAX phase, having at once a high specific mechanical resistance and a high resistance to oxidization in the temperature range of operation of a turbine, and less dense than materials made of nickel-based superalloys.

This aim is achieved within the scope of the present invention owing to a turbine component comprising a polycrystalline substrate, the substrate comprising grains and having at least one Ti₃AlC₂ phase, the mass fraction of said phase of the alloy being greater than 97%, each grain having a length and a width, characterized in that:
the average length of the grains is less than 50 μm; and
the average width-to-length ratio of the grains is between 0.4 and 0.6; and
the average cell volume of the Ti₃AlC₂ phase is less than 152.4 Å³.

As the average length of the grains is less than 50 μm and the average width-to-length ratio is between 0.4 and 0.6 and the average cell volume of the Ti₃AlC₂ phase is less than 152.4 Å³, the micromorphology of the Ti₃AlC₂ phase incurs a high resistance to oxidization within the working temperature range of a turbine.

The invention is advantageously completed by the following features, taken individually or in any one of their technically possible combinations:
the substrate comprises titanium carbide, the mass fraction of the titanium carbide of the substrate being less than 0.8%;
the substrate comprises alumina, the mass fraction of the alumina of the substrate being less than 3%;
the substrate comprises TiₓAl_{y} intermetallic compounds, the volume fraction of the TiₓAl_{y} compounds of the substrate being less than 1%;
the substrate has phases comprising iron and/or tungsten, and the sum of the average volume fraction of iron and of tungsten of said phases is less than 2%;
the relative density of the Ti₃AlC₂ phase is greater than 96%.

Another subject of the invention is a turbine blade characterized in that it comprises a component as previously described.

Another subject of the invention is a turbine stator characterized in that it comprises a component as previously described.

Another subject of the invention is a turbine characterized in that it comprises a turbine blade and/or a turbine stator as previously described.

Another subject of the invention is a method for manufacturing a turbine component, the component comprising a polycrystalline substrate, the substrate comprising grains and having at least one Ti₃AlC₂ phase, the mass fraction of said phase of the alloy being greater than 97%, each grain having a length and a width, the average length of the grains being less than 50 μm and the average width-to-length ratio being between 0.4 and 0.6, the average cell volume of the Ti₃AlC₂ phase being less than 152.4 Å³, characterized by the implementation of a step of flash sintering.

The invention is advantageously completed by the following features, taken individually or in any one of their technically possible combinations:
the temperature during the flash sintering step is less than 1400° C.;
the pressure during the flash sintering step is greater than 60 MPa;
the flash sintering step implements a heat treatment at a maximum temperature during less than ten minutes;
the flash sintering step comprises a sub-step of cooling, the cooling speed during the cooling sub-step being less than 100° C. per minute;
the method for manufacturing a component comprises steps of:
a) mixing and homogenizing of powders containing at least titanium, aluminum and carbon;
b) reaction sintering of the powders;
c) reduction to the powder state of the product of the reaction sintering of the powders;
the steps a) to c) being implemented before the step of flash sintering of the product of the milling.

### OVERVIEW OF THE DRAWINGS

Other features and advantages will become further apparent from the following description, which is purely illustrative and non-limiting, and must be read with reference to the appended figures, among which:

FIG. 1 schematically illustrates a section of a turbine component, for example a turbine blade or an airfoil of a nozzle guide vane;

FIG. 2 is a scanning electron microscopy photograph of the microstructure of a substrate of a turbine component;

FIG. 3 illustrates the mass gain of different substrates after processing incurring an isothermal oxidization;

FIG. 4 illustrates a MAX phase cell of 312 type;

FIG. 5 is a diagram illustrating the effect of the criterion of distortion of the cell volume and the relative density of the substrate on the variations of the secondary creep rate of the substrate;

FIG. 6 illustrates the creep in a Larson-Miller representation for different types of substrate;

FIG. 7 illustrates the change in the mass gain for several substrates having different cell volume distortion criteria during processing incurring an oxidization;

FIG. 8 illustrates the effect of the mass fraction of titanium carbide on the mass gain of substrates processed by oxidization;

FIG. 9 illustrates a method for manufacturing a component.

### DEFINITIONS

The term “length” L of a grain denotes the maximum size of the grain, on a straight line passing through the center of inertia of this grain.

The term “width” l of a grain denotes the minimum size of the grain, on a straight line passing through the center of inertia of this grain.

“Density” denotes the ratio of the mass of a given volume of the substrate to the mass of one and the same volume of water at 4 degrees and at atmospheric pressure.

“Relative density” denotes the ratio of the density of the substrate to the theoretical density of the same substrate.

“Larson-Miller parameter” denotes the parameter P given by the formula (1):

P=T(ln(tₜ+k)) (1)

where T is the temperature of the substrate in Kelvins, tᵣ is the time to rupture of the substrate for a specific stress and k is a constant.

“Stoichiometric compound” or “stoichiometric material” denotes a material composed of a plurality of elements, the atomic fraction of each element being an integer number.

### DETAILED DESCRIPTION OF AN EMBODIMENT OF THE INVENTION

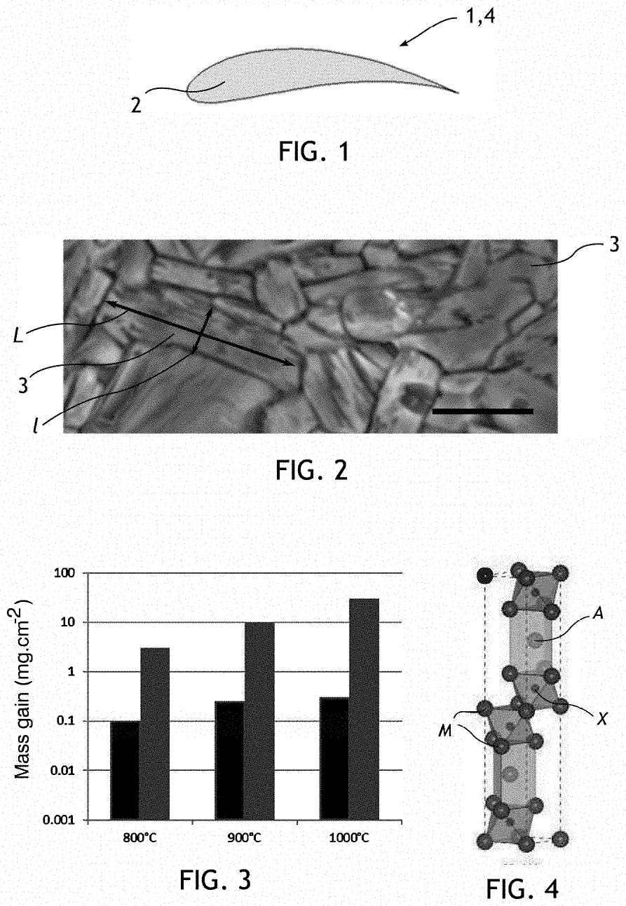

With reference to FIG. 1, a turbine component 1, such as a blade 4 comprises a polycrystalline substrate 2. This substrate has at least one Ti₃AlC₂ phase. The elements illustrated in FIG. 1 can be independently representative of the elements of a turbine blade 4, an airfoil of a nozzle guide vane, or any other element, part or component of a turbine.

With reference to FIG. 2, the polycrystalline substrate 2 comprises grains 3. The grains 3 of a substrate have several morphological parameters. In the Ti₃AlC₂ phase of the substrate 2, the length L of a grain 3 is on average less than 50 μm. In addition, the average form factor of a grain 3, i.e. the average ratio of the width of the grain 3 to the length of the grain 3 l/L, is between 0.3 and 0.7, preferably between 0.4 and 0.6 and preferably between 0.45 and 0.55. Thus, the microstructural parameters, relating to the average length of the grains 3 and to the average form factor, make it possible to increase the resistance of the substrate 2 to oxidization during the operation of the turbine, and make it possible to increase its resistance to creep. Specifically, the small size of the grains makes it possible to increase the area fraction of grain boundaries opening onto the surface of the substrate. Now, the grain boundaries allow a fast and preferential diffusion of elements of the alloy, for example aluminum, causing the formation of a layer of oxide. The majority of the aluminum can diffuse in order to form alumina on the surface. The layer of alumina thus formed is very stable and protective at high temperatures, making it possible to limit or prevent the mass gain of the substrate 2.

The average form factor of the grains combined with the grain size also makes it possible to improve the withstand to creep by avoiding slipping at the grain boundaries. The scale bar at the bottom right of the photograph corresponds to a length of 10 μm.

FIG. 3 illustrates the mass gain of different substrates after processing incurring isothermal oxidization. Two types of substrates are oxidized: a first type of substrate 2, in accordance with the invention, corresponding to the black bars in FIG. 3, wherein the average length of the grains 3 of the Ti₃AlC₂ phase is substantially equal to 10 μm, and a second type of substrate, different from the invention, corresponding to the grey bars in FIG. 3, wherein the average length of the grains of the Ti₃AlC₂ phase is substantially equal to 60 μm. The mass gain is measured after an isothermal oxidization. The isothermal oxidization is implemented at different temperatures (800° C., 900° C. and 1000° C.), in air and during 30 hours. For all the oxidization temperatures, the substrates 2 in which the average length of the grains 3 is substantially equal to 10 μm have a mass gain smaller by over an order of magnitude than the mass gain exhibited by the substrates in which the average length of the grains is substantially equal to 60 μm. Thus, a substrate 2 in which the average length of the grains 3 is less than 50 μm has a high resistance to oxidization.

FIG. 4 illustrates a MAX phase cell of 312 type. In general, a MAX phase (comprising elements M, A and X) has a hexagonal structure. The hexagonal cell of a MAX phase is formed of octahedrons M₆X, organized in layers, between which are inserted layers of elements A. The theoretical volume of the cell of Ti₃AlC₂ is known, and equal to V₀=153.45 Å³. According to an aspect of the invention the average volume of the cells of the Ti₃AlC₂ phase is different from the theoretical volume. The term of cell volume distortion criterion denotes the parameter δ given by the formula (2):

$$δ = \frac{{V}_{0} - {V}_{mes}}{{V}_{0}} \qquad ( 2 )$$

where Vₘₑₛ is equal to the average volume of the cell measured for the Ti₃AlC₂ phase of the substrate 2. This volume can be calculated after determining the cell parameters by Rietveld refinement of the diffractograms obtained by X-Ray Diffraction (XRD), for example measured in an angular range between 7° and 140°. The variation of the parameter δ is mainly driven by any contaminations by chemical elements during the manufacturing of the substrate 2. This parameter δ can also vary with manufacturing parameters of the substrate 2 such as pressure, temperature and/or the duration of the processing of the substrate 2 during manufacturing.

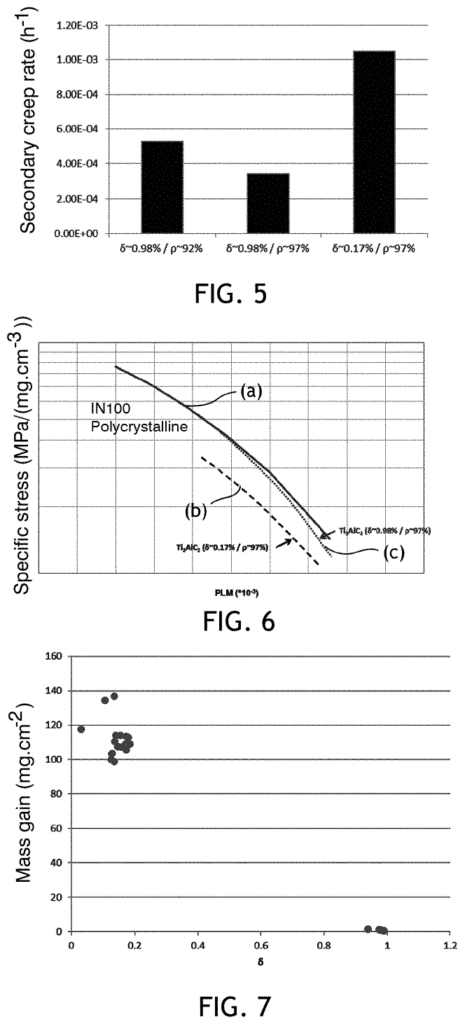

FIG. 5 is a diagram illustrating the effect of the parameter δ and the relative density of the substrate on the variations of the secondary creep rate of the substrate 2. The secondary creep rate is measured on substrates 2 processed at a temperature of 900° C. and subjected to a tensile stress of 140 MPa. The substrates 2 used for the measurements illustrated in FIG. 5 have a volume fraction of the Ti₃AlC₂ phase greater than 98% and have different relative densities. For a relative density equal to 97% (corresponding to the center column and to the right-hand column in FIG. 5), the secondary creep rate is illustrated for two parameters δ (δ=0.98% and δ=0.17%). The substrate has a secondary creep rate that is higher for δ=0.17% and lower for δ=0.98%. In general, the substrate has a higher secondary creep rate when δ<0.7%. Thus, a substrate 2 having a parameter δ>0.7% allows the substrate 2 to better resist creep. The parameter δ characterizes a separation between the actual or measured volume of the cell of the MAX phase and the theoretical or reference volume of the cell. Thus, when δ increases, the cell volume of the MAX phase decreases, which is the result of the different layers of elements A and the octahedrons M₆X coming closer together. The relationship between the parameter δ and the withstand to creep of a substrate 2 is unexpected. It might perhaps be possible to explain this effect by a slowdown of the motion of the dislocations, thus making it possible to improve the withstand of this material to creep. Preferably, the delta parameter is between 0.7 and 2% and preferably between 0.92 and 1%. Considering that V₀=153.45 Å³ for a Ti₃AlC₂ phase, the average volume of a cell of the Ti₃AlC₂ phase of a substrate 2 is less than 152.4 Å³. Preferably, the average cell volume of the Ti₃AlC₂ phase is between 150.38 Å³ and 152.37 Å³, and preferably between 151.91 Å³ and 152.03 Å³. The effects of the cell volume previously described are preferably observed when the average length of the grains is less than 50 μm and the average width-to-length ratio of the grains is between 0.4 and 0.6.

For a parameter δ equal to 0.98% (corresponding to the left-hand column and to the center column of FIG. 5), the secondary creep rate is illustrated for two different relative densities ρ (ρ=92%, corresponding to the left-hand column and ρ=97%, corresponding to the center column). Thus, a relative density ρ of the substrate 2 greater than 96% makes it possible to reduce the creep rate with respect to a relative density of the substrate 2 less than 96%. Specifically, the volume of material stressed during the creep is smaller when the density decreases. For an imposed external stress, the forces, on the scale of the microstructure, increase when the relative density decreases. Thus the creep lifetime decreases when the density decreases.

FIG. 6 illustrates the creep in a Larson-Miller representation for different types of substrates. The specific stress is represented as a function of the Larson-Miller parameter. The curve (a) corresponds to a substrate made of known polycrystalline nickel-based superalloy. The curve (b) corresponds to a substrate comprising a Ti₃AlC₂ phase and have a cell distortion criterion of δ equal to 0.17%. The curve (c) corresponds to a substrate 2 in accordance with the invention, comprising a Ti₃AlC₂ phase, and having a cell distortion criterion δ equal to 0.98%. The feature of the substrate 2, corresponding to the curve (c), has a specific stress similar to that of the nickel-based substrate; on the other hand the feature of the substrate corresponding to the curve (b) has, for a predetermined value of the Larson-Miller parameter, a specific stress substantially an order of magnitude lower than the specific stress of a substrate 2 corresponding to the curve (c). Thus, a substrate 2 implemented in a component 1 has a mechanical resistance higher than a known substrate having a Ti₃AlC₂ phase.

FIG. 7 illustrates the change in the mass gain for several substrates having different parameters δ, during a processing incurring oxidization. The oxidization is incurred by a cyclic heat treatment of each substrate between 100° C. and 1000° C., maintaining the temperature of 1000° C. during one hour for each cycle, during 240 cycles. A surface mass gain between 90 and 140 mg/cm² is measured on the substrates having a parameter δ less than 0.7%. On the other hand, the substrates 2 having a parameter δ greater than 0.7% have a substantially zero mass gain. Thus, the substrates 2 in accordance with the invention have a resistance to oxidization, under temperature conditions corresponding to the work of a turbine, higher than known substrates.

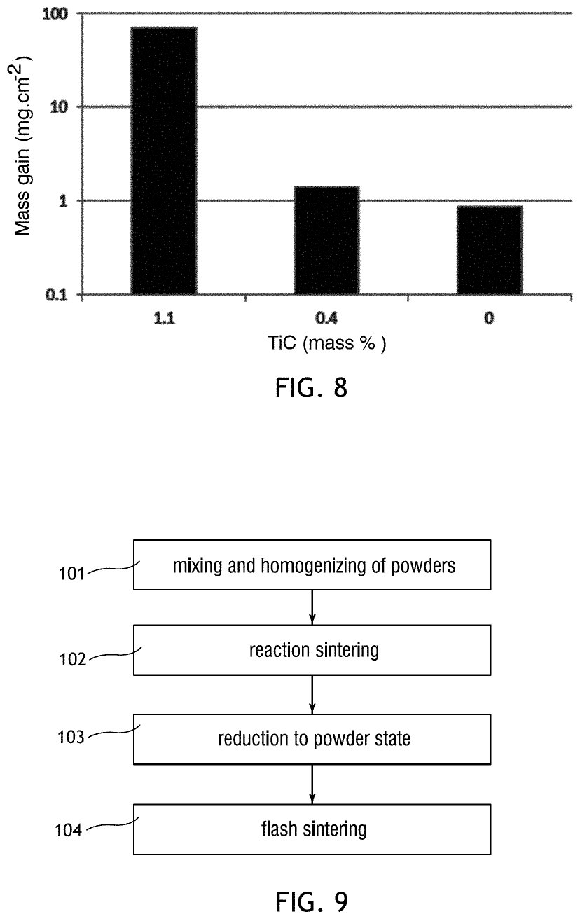

FIG. 8 illustrates the effect of the mass fraction of titanium carbide on the mass gain of substrates after processing incurring oxidization. The oxidization of the substrates is implemented controlling one hundred heat cycles, under air. Each cycle corresponds to the heat treatment of a substrate from 100° C. to 1000° C., following a temperature gradient of 5° C./min, followed by a treatment of the substrate at a temperature of 1000° C. during one hour, then a cooling from 1000° C. to 100° C.

Three substrates are heat treated. Each of the substrates has a different titanium carbide (TiC) mass fraction: 1.1% (illustrated by the left-hand column of FIG. 8), 0.4% (illustrated by the middle column of FIG. 8) and 0% (illustrated by the right-hand column in FIG. 8). Thus, the oxidization of the substrate can be significantly reduced by decreasing the mass fraction of TiC in the substrate. Advantageously, the substrate 2 according to an aspect of the invention has a mass fraction of TiC less than 0.8% in such a way as to reduce the oxidization incurred by the work temperatures of a turbine.

With reference to FIG. 9, a method for manufacturing a component 1 can comprise the following steps.

In a step 101 of the method for manufacturing the component 1, powders are mixed containing titanium, aluminum and carbide, to be densified. Powders of TiC_{>0.95}, aluminum and titanium can for example be mixed in respective proportions in atomic fraction of 1.9 at %/1.05 at %/1 at %. It is for example possible to homogenize the powders by using a mixer of Turbula (trademark) type or any equivalent type of three-dimension mixer. Preferably, the atomic fraction of aluminum powder mixed is strictly greater than 1, and preferably between 1.03 and 1.08. Specifically, the evaporation of Al during the subsequent reaction sintering processing incurs a reduction of the atomic fraction of aluminum of the component obtained at the end of the process. Thus, an atomic fraction of aluminum between 1.03 and 1.08 in step 101 makes it possible to manufacture a stoichiometric compound. Thus, according to an aspect of the invention, the substrate has phases comprising iron and/or tungsten, and the sum of the average volume fraction of iron and of tungsten of said phases is less than 2%.

In a step 102 of the method, reaction sintering of the powders mixed in step 101 is implemented. The reaction sintering can be implemented in a protective atmosphere during two hours at 1450° C.

In a step 103 of the method, the products of step 102 are reduced to the powder state, for example by milling.

In a step 104 of the method, flash sintering (or SPS for Spark Plasma Sintering), is implemented. Rash sintering is for example implemented at a temperature of 1360° C., during two minutes, at 75 MPa, while controlling a cooling occurring at −50° C. min⁻¹. The temperature, in the flash sintering step 104, is advantageously less than 1400° C. This is because flash sintering at a temperature less than 1400° C. makes it possible to avoid the decomposition of the Ti₃AlC₂ phase. In addition, flash sintering at a temperature less than 1400° C. makes it possible to avoid an interaction and/or contamination of the product of step 103 by the material forming the mold of the flash sintering device, comprising graphite for example. The pressure during the flash sintering step is advantageously greater than 60 MPa. This is because this pressure, higher than the pressures used during the implementation of sintering according to known methods, makes it possible to manufacture a component 1 having a relative density of the Ti₃AlC₂ phase greater than 96%, in which the average length of the grains 3 is less than 50 μm and in which the average width-to-length ratio of the grains is between 0.4 and 0.6. Advantageously, the step of flash sintering implements a heat treatment at a maximum temperature during less than ten minutes. Thus, excessive growth and the deterioration of the properties of the grains 3 of the substrate 2 are avoided. The step 104 comprises a sub-step of cooling, after maintaining the substrate 2 at a maximum temperature. Advantageously, the standard of the cooling speed during this sub-step is less than 100° C. min⁻¹. This avoids the accumulation of residual mechanical stresses in the substrate 2 during the cooling sub-step. Residual stresses are problematic during the manufacturing of components as they incur cracking of the material, for example during the machining of the substrate. The risks of cracking during machining thus decreases during the implementation of a method of manufacturing according to an aspect of the invention.

The manufacturing of a component 1 according to a method previously described allows the substrate to have the properties of a stoichiometric material, and makes it possible to avoid or limit the inclusion of compounds degrading the performance of the material with regard to the oxidization or the mechanical resistance. Thus, according to an aspect of the invention, the mass fraction of the alumina of the substrate is less than 3%. According to another aspect of the invention, the substrate comprises TiₓAl_{y} intermetallic compounds, the volume fraction of these compounds being less than 1%.

1. A turbine component comprising a polycrystalline substrate, the substrate comprising grains and having at least one Ti₃AlC₂ phase, the mass fraction of said phase of the alloy being greater than 97%, each grain having a length and a width, wherein:
the average length of the grains is less than 50 μm; and
the average width-to-length ratio of the grains is between 0.4 and 0.6; and
the average cell volume of the Ti₃AlC₂ phase is less than 152.4 Å³.

2. The turbine component as claimed in claim 1, wherein the substrate comprises titanium carbide, the mass fraction of the titanium carbide of the substrate being less than 0.8%.

3. The turbine component as claimed in claim 1, wherein the substrate comprises alumina, the mass fraction of the alumina of the substrate being less than 3%.

4. The turbine component as claimed in claim 1, wherein the substrate comprises TiₓAl_{y} intermetallic compounds, the volume fraction of the TiₓAl_{y} compounds of the substrate being less than 1%.

5. The turbine component as claimed in claim 1, wherein the substrate has phases comprising iron and/or tungsten, and wherein the sum of the average volume fraction of iron and of tungsten of said phases is less than 2%.

6. The turbine component as claimed in claim 1, wherein the relative density of the Ti₃AlC₂ phase is greater than 96%.

7. The turbine blade comprising a component as claimed in claim 1.

8. The turbine stator comprising a component as claimed in claim 1.

9. The turbine comprising a turbine blade and/or a turbine stator comprising a polycrystalline substrate, the substrate comprising grains and having at least one Ti₃AlC₇ phase, the mass fraction of said phase of the alloy being greater than 97%, each grain having a length and a width, wherein:
the average length of the grains is less than 50 μm; and
the average width-to-length ratio of the grains is between 0.4 and 0.6; and
the average cell volume of the Ti₃AlC₂ phase is less than 152.4 Å³.

10. A method for manufacturing a turbine component, the component comprising a polycrystalline substrate, the substrate comprising grains and having at least one Ti₃AlC₂ phase, the mass fraction of said phase of the alloy being greater than 97%, each grain having a length and a width, the average length of the grains being less than 50 μm and the average width-to-length ratio being between 0.4 and 0.6, the average cell volume of the Ti₃AlC₂ phase being less than 152.4 Å³, wherein said method comprises a step of flash sintering.

11. The method as claimed in claim 10, wherein the temperature during the flash sintering step is less than 1400° C.

12. The method as claimed in claim 10, wherein the pressure during the flash sintering step is greater than 60 MPa.

13. The method as claimed in claim 11, wherein the flash sintering step implements a heat treatment at a maximum temperature during less than ten minutes.

14. The method as claimed in claim 11, wherein the flash sintering step comprises a sub-step of cooling, during which the cooling speed is less than 100° C. per minute.

15. The method as claimed in claim 11, further comprising steps of:
a) mixing and homogenizing of powders containing at least titanium, aluminum and carbon;
b) reaction sintering of the powders;
c) reduction to the powder state of the product of the reaction sintering of step b);
the steps a) to c) being implemented before the step of flash sintering of the product of the milling.
